(19) United States
(12) Patent Application Publication
(10) Pub. No.: US 2016/0286725 A1
(43) Pub. Date: Oct. 6, 2016

(54) Crop Processor, Manufacturing Process for a Crop Processor and Crop Processor Roll

(71) Applicant: CNH INDUSTRIAL AMERICA LLC, New Holland, PA (US)

(72) Inventor: Jan-Pieter Vanden Broucke, Boezinge (BE)

(21) Appl. No.: 15/037,259

(22) PCT Filed: Nov. 20, 2014
(86) PCT No.: PCT/EP2014/075215

§ 371 Date: May 17, 2016

(30) Foreign Application Priority Data
Nov. 20, 2013 (BE) 2013/0784

(51) Int. Cl. A01D 43/10; A01D 82/02

(52) U.S. Cl. CPC A01D 43/10; A01D 82/02; A01D 2101/00

(57) ABSTRACT

A crop processor for a forage harvester. The crop processor includes a housing having an inlet and an outlet. The crop processor further includes a pair of crop processor rolls mounted inside the housing. The crop processor rolls are made of a metal, are arranged parallel to each other, and have a gap in between. The crop processor is configured to, during use, transport a flow of harvested crop, received from the inlet, through the gap towards the outlet. Each of the crop processor rolls comprises a plurality of teeth arranged along a circumference of the crop processor rolls. The plurality of teeth have a height in radial direction and a length extending in an axial direction of the crop processor rolls. The plurality of teeth of the crop processor rolls are manufactured to comprise a substantially flat top surface of a predetermined width (W).

### CROSS REFERENCE TO RELATED APPLICATIONS

This application is a U.S. national phase application of PCT International Application PCT/EP2014/075215, filed Nov. 20, 2014 and entitled “Crop Processor, Manufacturing Process for a Crop Processor and Crop Processor Roll,” which claims priority to Belgian Application No. 2013/0784, filed Nov. 20, 2013, the contents of which application is incorporated herein by reference.

### FIELD OF THE INVENTION

The invention relates to the field of forage harvesters, and more specifically to crop processors for cracking crop kernels in such harvesters.

### BACKGROUND OF THE INVENTION

Forage harvesters are operable to harvest crop from a field and comminute it before expelling the cut crop through a spout often equipped with a so-called crop processor that cracks the kernels, e.g. corn kernels, in the harvested crop. Typically, such a crop processor comprises a pair of crop processing rolls, each having a plurality of teeth on their circumference; the teeth having a height in radial direction and extending in axial direction of the rolls. During use, the harvested crop is passed through a small opening, i.e. a gap, between the outer peripheries of the rolls, thereby cracking the kernels by means of the teeth. Typically, the pair of crop processing rolls is mounted in a housing comprising an inlet and an outlet, whereby, during use, a flow of harvested crop, received via the inlet, is processed by the crop processor rolls while being transported through the gap and is outputted via the output of the housing. The rolls typically are rotated at different circumferential speeds, such that they rotate the kernels during their passage through the gap and the teeth engage the kernels multiple times before leaving the crop processor.

In a common configuration, the teeth as applied have a saw tooth profile, whereby the harvested crop is hit by the aggressive side of the teeth of one roll and the less aggressive (more smooth) side of the teeth of the other roll.

Such an arrangement may have the following drawbacks:

The roll that uses its less aggressive side may compress any recirculating material against the crop processor housing, which may result in a layer of dried up solid material that builds up until it reaches the tip of the teeth. When the teeth come in contact with such a layer of hard dried up material, they start to wear. Note that this phenomenon will also, but to a lesser extent, occur when a symmetrical tooth profile is applied.

Local wear of the teeth may result in irregular gaps between both rolls of the processor, decreasing the effectiveness of the cracking process. Such irregular gaps between both rolls make it difficult or even impossible to adjust the gap, e.g. during a maintenance operation, within a desired distance.

Other known teeth arrangements are found to equally suffer from wear on the tip of the teeth.

Further, the cracking process itself may be an important cause of wear. The wear caused by the cracking process may also result in an irregular gap between the rolls, e.g. when the flow of material is not uniformly distributed along the length of the rolls.

### SUMMARY OF THE INVENTION

It would be desirable to provide a crop processor for a forage harvester that has an improved resistance to wear. To address this concern, in an aspect of the invention, a crop processor for cracking kernels in a forage harvester is provided, the crop processor comprising:

a housing having an inlet and an outlet; and

a pair of crop processor rolls mounted inside the housing, the crop processor rolls being made of a metal, being arranged parallel to each other and having a gap in between, the crop processor being configured to, during use, transport a flow of harvested crop, received from the inlet, through the gap towards the outlet; wherein each of the crop processor rolls comprises a plurality of teeth arranged along a circumference of the crop processor rolls, the plurality of teeth having a height in radial direction and a length extending in an axial direction of the crop processor rolls and wherein the plurality of teeth of the crop processor rolls are manufactured to comprise a substantially flat top surface of a predetermined width.

In accordance with the aspect of the invention, a crop processor is provided with a pair of crop processor rolls, each comprising a plurality of teeth arranged along a circumference of the rolls. Typically, the rolls may be provided with e.g. 90-170 teeth. The teeth extent along the axial direction of the rolls, substantially over the entire length of the rolls. Both processor rolls are positioned adjacent each other and extending in the same direction, thereby having a gap between the crop processing rolls of typically 1-3 mm.

The crop processor further comprises a housing having an inlet and an outlet, the crop processor rolls being mounted inside the housing, such that, during operation, harvested crop, which is received by the inlet, passes through the gap and is cracked, by the operation of the teeth and transported towards the outlet.

In accordance with the first aspect of the invention, the teeth of the processor rolls are manufactured to comprise a substantially flat top surface. The tip of the teeth of the processor rolls as applied in the present invention is thus not point-shaped (as found in known processors) but has a flat top surface, typically having a predetermined width of 0.4-1 mm, preferable in the range of 0.4-0.8 mm.

The application of the substantially flat top surface has been found to improve the wear resistance of the processor rolls. Due to the increased width at the top of the teeth (compared to a point-shaped or rounded tip), the teeth more easily withstand the forces exerted by the harvested crop and thus wear off at a slower pace In particular, the diameter of the roll reduces at a slower pace, resulting a more uniform gap between the rolls, for a longer period of time. In accordance with the present invention, the width of the substantially flat top surface is determined by appropriate processing of the rolls, e.g. by a final machining of the rolls when the teeth are already in place or by an appropriate positioning of the teeth, resulting in a predetermined width of the top surface.

In an embodiment, the teeth have a symmetrical shape. Compared to known teeth profiles of crop processor rolls, which are typically saw tooth profiles, the use of a symmetrical profile or shape provides the further advantage that, when one side of the teeth has been affected by wear, the rolls may be swapped and by doing so, the other side of the teeth is applied to contact the harvested crop.

In accordance with an aspect of the present invention, various manufacturing methods for crop processor rolls are provided, enabling the desired tooth profile, i.e. comprising a substantially flat surface.

In another aspect of the present invention, a first manufacturing method for a crop processor for cracking kernels in a crop processor is provided, the method comprising the steps of:

manufacturing a pair of crop processor rolls by
providing a pair of substantially cylindrically shaped metal rolls; and
machining a plurality of teeth in the substantially cylindrically shaped rolls, thereby maintaining part of an outer surface of the rolls unaffected, the part of the outer surface forming a substantially flat top surface of the plurality of teeth, the substantially flat top surface having a predetermined width; and

assembling the pair of crop processor rolls into a housing having an inlet and an outlet, the crop processor rolls being arranged parallel to each other and having a gap in between, the housing and the crop processing rolls being configured to, during use, transport a flow of harvested crop, received from the inlet, through the gap towards the outlet.

In the first manufacturing method according to the present invention, a substantially flat top surface of the teeth of the processor roll is realized by machining the teeth in such manner that part of the outer surface of the roll is unaffected. This can e.g. be realized by selecting an appropriate tooth pitch or tooth angle or tooth depth. In such embodiment, the substantially flat top surface of the teeth is thus part of the initial outer surface of the substantially cylindrically shaped roll. In accordance with the present invention, the initial outer surface refers to the outer surface of the rolls prior to the machining of the teeth.

Note that, in accordance with the present invention, a surface have a curvature corresponding to the curvature of the outer surface of the processor roll, is considered a substantially flat surface.

In yet another aspect of the present invention, there is provided a second manufacturing method for a crop processor for cracking kernels in a forage harvester, the method comprising the steps of:

manufacturing a pair of crop processor rolls by
providing a pair of substantially cylindrical shaped metal rolls;
machining a plurality of teeth in the substantially cylindrically shaped rolls;
hardening the cylindrically shaped rolls; and
grinding the hardened cylindrically shaped rolls to a diameter that is smaller than an initial diameter of the cylindrically shaped rolls, thereby providing the plurality of teeth with a substantially flat top surface of a predetermined width; and

assembling the pair of crop processor rolls into a housing having an inlet and an outlet, the crop processor rolls being arranged parallel to each other and having a gap in between, the housing and the crop processing rolls being configured to, during use, transport a flow of harvested crop, received from the inlet, through the gap towards the outlet.

In the second manufacturing method according to the present invention, the substantially flat top surface of the teeth is provided by a grinding process that is preceded by a hardening process. Instead of the mentioned grinding, alternative methods to reduce the diameter of the rolls such that a substantially flat top surface is obtained may be considered as well. The second manufacturing method according to the present invention provides in the following advantages:

When a hardening process is performed, it may be noticed that the diameter of the roll, after hardening, has changed in a non-uniform manner. In particular, the diameter in the middle of the roll will typically be smaller than the diameter at the ends of the roll. As a result, when two such rolls are mounted adjacent each other to form a crop processor, a non-uniform gap will occur between the rolls, which may adversely affect the effectiveness of the processing of the harvested crop by the crop processor. In this respect, it can be noted that such an increased gap near the middle of the roll is in particular unwanted, because a large portion of the crop material flow is processed in that region.

By performing a grinding step on the hardened roll, a uniform diameter may again be obtained, i.e. the non-uniformity of the diameter which has occurred due to the hardening process can be removed, by the application of the grinding step afterwards.

With respect to the hardening process, the following is also worth mentioning: It has been observed by the inventors that, when conventional tooth shapes are applied, an appropriate hardening of the tip of the teeth is difficult to realize. Typically, the hardening process comprises a first heating step, e.g. using an inductive heating process, a quenching step to cool the roll, followed by a tempering step, i.e. a second heating step to reduce the brittleness of the roll. In case of a processor roll provided with a plurality of teeth along the circumference, it has been observed that it is difficult to realize the appropriate temperature in the tip of the teeth, during both the first and second heating steps. As a result, the tip of the teeth may be softer than desired. By applying any of the manufacturing methods according to the present invention, the tip of the teeth is either not present when the roll is hardened or removed after the hardening step, thus resulting in improved mechanical properties, with respect to hardness, of the top of the teeth. By applying any of the manufacturing methods according to the present invention, the teeth of the processor rolls are provided with a substantially flat top surface having a predetermined width, i.e. a width of the top surface being determined or defined by the manufacturing process as applied. In particular, with respect to the first manufacturing method according to the present invention, the predetermined width of the top surface is determined by the selected tooth pitch and applied tooth profile. In the second manufacturing method according to the present invention, the predetermined width is determined by the diameter reduction that is applied by the grinding or alternative process. An appropriate selection of the diameter reduction may thus result in a desired predetermined width of the substantially flat top surface of the teeth.

In an embodiment, the crop processor rolls as applied in the present invention may be provided with a Chromium coating, in order to further improve the wear resistance.

Both first and second manufacturing methods further may comprise the step of assembling the pair of crop processor rolls into a housing having an inlet and an outlet, the crop processor rolls being arranged parallel to each other and having a gap in between, the housing and the crop processing rolls being configured to, during use, transport a flow of harvested crop, received from the inlet, through the gap towards the outlet.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 depicts a cross-sectional view of a crop processor as known in the art.

FIG. 2 depicts a tooth profile for a crop processor roll as known in the art.

FIG. 3 depicts a detail of a know crop processor roll mounted in a housing.

FIG. 4 depicts a cross-sectional view of a crop processor according to the present invention.

FIG. 5 depicts the effect of wear on a tooth profile as can be applied in the crop processor according to the invention.

FIG. 6 depicts the effect of having a flat top surface on the tooth angle.

FIG. 7 depicts a pair of crop processor rolls in assembled state.

FIGS. 8(a) and 8(b) depict a machining step for a known manufacturing method and a method according to the invention.

FIG. 9 depicts a possible effect of a hardening process on a diameter of a crop processor roll.

FIG. 10 depicts a first manufacturing method.

FIG. 11 depicts a second manufacturing method.

### DETAILED DESCRIPTION OF EMBODIMENTS

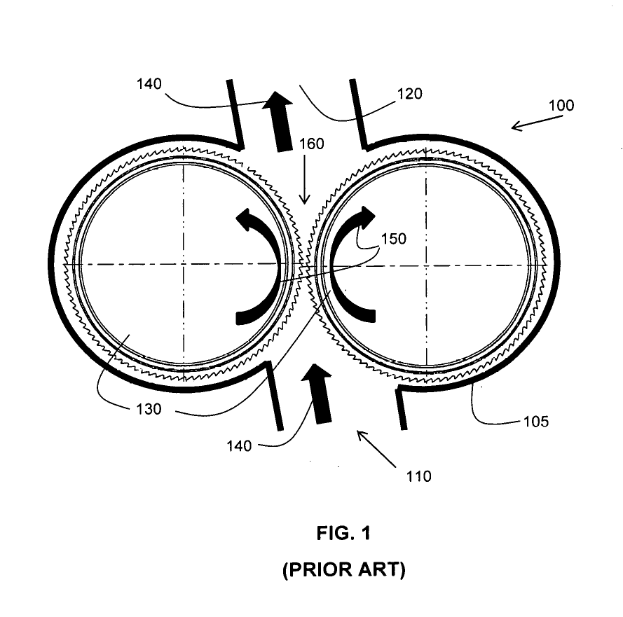

FIG. 1 depicts a cross-sectional view of a crop processor 100 as known in the art. The crop processor 100 comprises a housing 105 having an inlet 110 and an outlet 120 and a pair of processor rolls 130 arranged in a path (indicated by the arrows 140) between the inlet 110 and the outlet 120.

As can be seen, both crop processor rolls 130 are provided with a plurality of teeth along the circumference of the rolls. In the arrangement as shown, the roll on the left is arranged to rotate in counterclockwise direction whereas the roll on the right rotates in clockwise direction (as indicated by arrows 150). By doing so, a flow of harvested crop, entering the crop processor via the inlet 110, is taken along by the teeth and forced thought the gap 160 that is provided between the outer cylindrical peripheries of the rolls 130 and further towards the outlet.

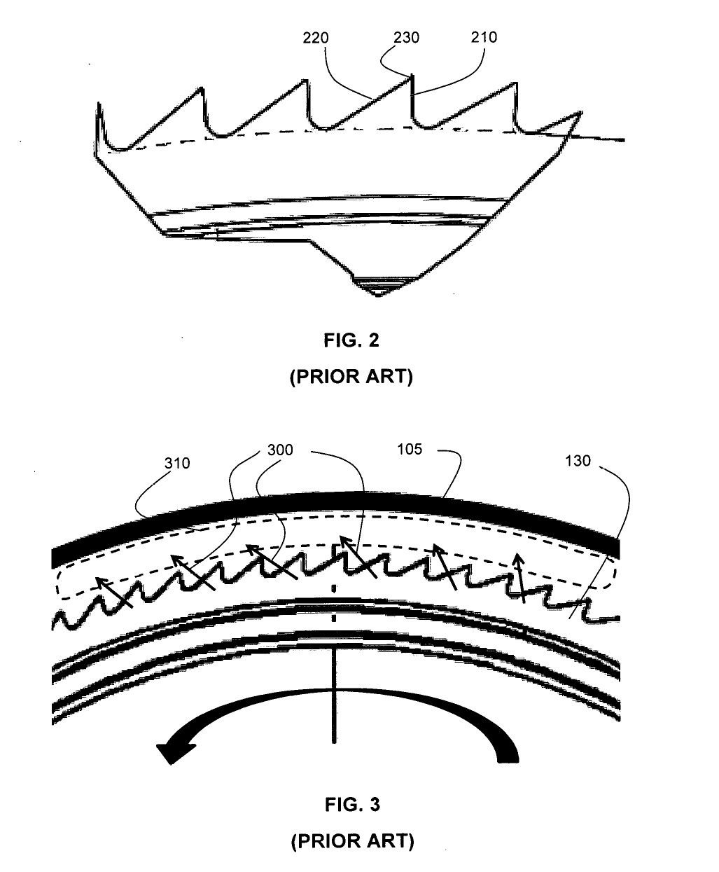

In FIG. 2, a more detailed view of the tooth profile is shown. As can be seen, the known tooth profile is an asymmetrical tooth profile, having a side with a steep slope 210, also referred to as the aggressive side, and a side with a smoother slope 220, referred to as the less aggressive side. It can further be mentioned that the tooth as shown are provided with a sharp tip 230.

Typically, as can also be seen in FIG. 1, the pair of crop processor rolls is arranged in such manner that the harvested crop which enters the processor via the inlet (e.g. inlet 110 of FIG. 1) is hit by the aggressive side of the teeth of one roll and the less aggressive (more smooth) side of the teeth of the other roll. As a consequence, a build-up of crop contamination may occur between the housing and one of the rolls. Such a build-up is schematically shown in FIG. 3. FIG. 3 schematically shows part of the housing 105 and the roll 130 on the left of FIG. 1. Harvested crop that has passed the gap between the rolls (not shown) and which is not evacuated via the outlet, can be transported, pushed towards the housing (indicated by the arrows 300) and fill the region indicated by the dotted line 310. Because the crop is pushed by the less aggressive side of the teeth of the roll 130, the crop remains in the indicated region 310 and becomes a layer of dried, solid material which eventually causes the tooth tips to wear off. Because the build-up of material may be irregular along the length of the roll, the occurring wear will also be irregular, resulting in an irregular gap between the rolls. As a result, the effectiveness of the cracking process of the harvested crop deteriorates. It can be noted that the issue as discussed primarily occurs when the harvested crop is transported by the less aggressive side of the teeth. In the area between the housing 105 and the roll 130 on the right of FIG. 1, the problem is thus less stringent. Note however that this described wear process may also occur when a symmetrical tooth profile is applied. In addition, the cracking process itself also results in wear of the teeth and thus results in the occurrence of an irregular enlarged gap between the rolls.

In accordance with the present invention, an alternative tooth profile is proposed which is less susceptible to wear. This is realized by manufacturing the plurality of teeth of the crop processor rolls such that they comprise a substantially flat top surface of a predetermined width. In accordance with the present invention, such a substantially flat top surface of a predetermined width can be implemented in both symmetrical and non-symmetrical tooth profiles.

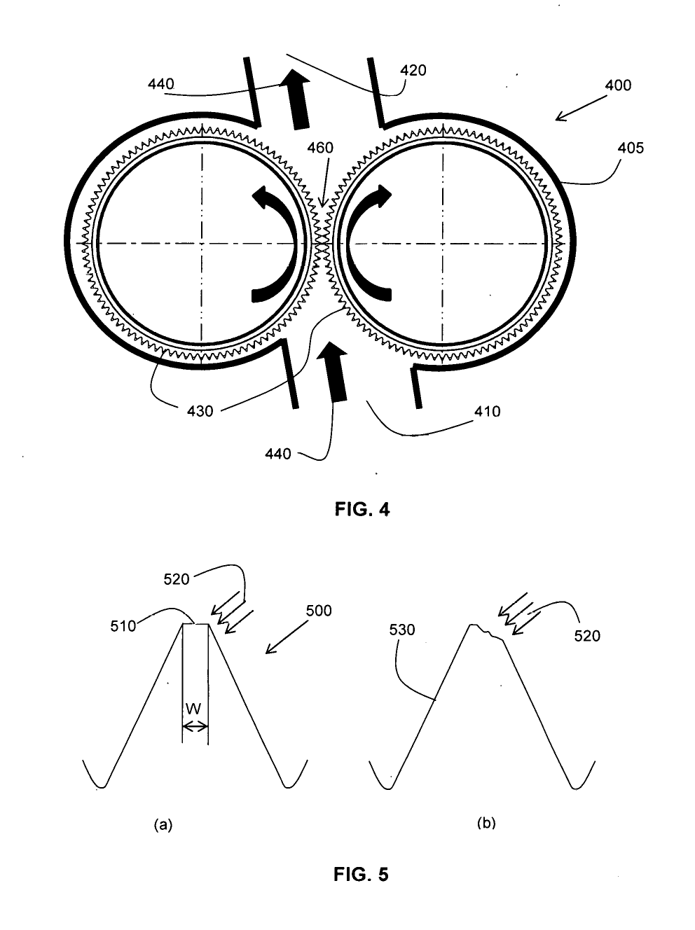

FIG. 4 schematically shows an embodiment of a crop processor according to the present invention, wherein the crop processor rolls are provided with symmetrical teeth, having a substantially flat top surface of a predetermined width. The crop processor 400 as shown in FIG. 4 comprises a housing 405, similar to the housing 105 of FIG. 1, having an inlet 410 and an outlet 420, and two crop processor rolls 430, mounted inside the housing, parallel and adjacent to each other, thus defining a gap 460 in between them. As can be seen from FIG. 4, the processor rolls 430 and the gap 460 are arranged in the path followed by the harvested crop from the inlet 410 to the outlet 420, indicated by the arrows 440. Harvested crop entering the crop processor via the inlet 410 is thus taken along by the teeth of the rotating processor rolls (the direction of rotation being indicated by the arrows 450), processed (i.e. cracked) in the gap between the rolls 430 and outputted via the outlet 420.

In accordance with the present invention, the crop processor rolls 430 are provided with a plurality of teeth along the circumference, the teeth having a height extending in radial direction and a length in axial direction substantially corresponding to the length of the rolls. The teeth as applied are further provided with a substantially flat top surface of a predetermined width, see further on.

Due to the application of the substantially flat top surface, the teeth as provided are less susceptible to wear. As such, in case of the application of an asymmetrical tooth profile, resulting in the clogging issue as discussed in FIG. 3, the layer of dried, solid material that may stick to the housing will, due to the wider tooth tip (compared to a sharp tooth tip as applied in know crop processors), result in less wear. In particular, due to the wider tooth tip, the occurring wear will, in a first instance, only affect the width of the teeth, the height of the teeth remaining unaffected. This is schematically illustrated in FIG. 5, showing a symmetrical tooth profile as can be applied in a crop processor according to the present invention.

FIG. 5(a) schematically shows a tooth profile 500 having a substantially flat top surface 510 with a width W. FIG. 5(a) further shows an indication of the area (indicated by the arrows 520) which is most susceptible to wear, e.g. due to clogged material between the housing and the processor rolls. FIG. 5(b) schematically shows the effect of such wear on the tooth profile. As can be seen, even when an important part of the tooth tip is removed due to wear, the overall height of the tooth may remain unaffected. Consequently, the gap between the adjacent rolls of the crop processor remains unaffected. It can be noted that, as can be seen in FIG. 5(b), the slope of the tooth profile may however be affected. If this would affect the effectiveness of the cracking process, one could consider switching both rolls, thereby enabling the cracking process, which occurs in the gap between the rolls, to be performed with the unaffected tooth side, i.e. side 530 as indicated in FIG. 5(b).

Typically, crop processor rolls as applied in a crop processor according to the present invention may have a diameter ranging from 200 mm to 300 mm and are provided with a number of teeth along the circumference, ranging from 90 to 170. The height or depth of the teeth is typically in the range from 3-7 mm.

In order to effectively improve the wear resistance, it has been found that a substantially flat top surface having a width ranging from 0.4-1 mm, preferably ranging from 0.4-0.8 mm may be applied.

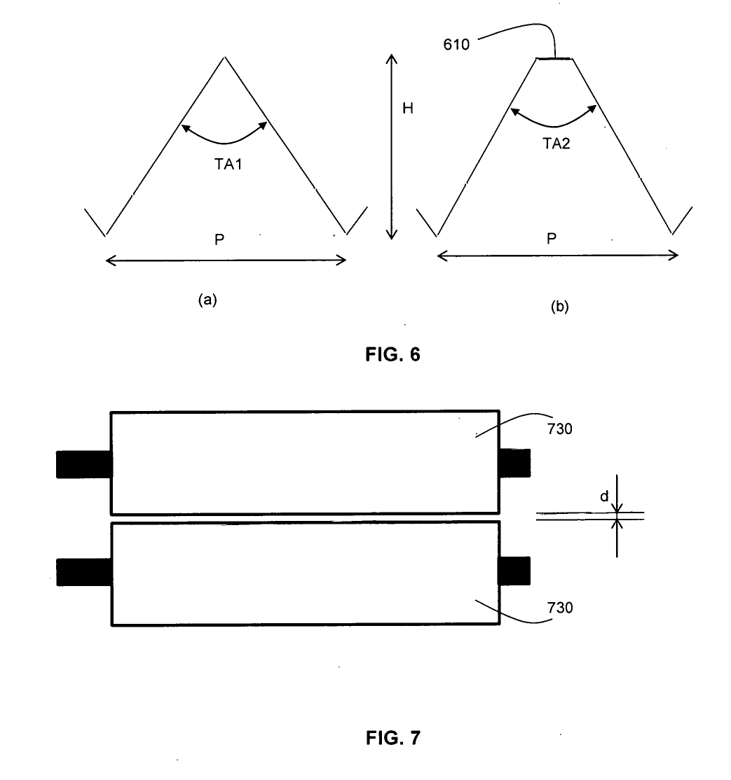

As a consequence of the application of the substantially flat top surface, it can be noted that (considering the same number of teeth having the same depth) steeper slopes can be applied to the tooth profile, compared to a tooth profile having a sharp tip, while maintaining the overall strength of the teeth. By applying a more steeper slope or, phrased differently, by applying a smaller tooth angle, the cracking process becomes more effective. In accordance with the present invention, the term tooth angle is used to denote the angle between the two surfaces that form a tooth. FIG. 6 (a) schematically shows a tooth profile with a sharp tip and corresponding tooth angle TA1, whereas FIG. 6 (b) shows a tooth profile, having the same pitch P, and having a substantially flat top surface 610. When both profiles have the same height, it will be apparent that tooth angle TA2 will be smaller than TA1. Due to the application of the substantially flat top surface, the tooth angle TA2 may even be reduced further resulting, when the pitch P is maintained, in an increased tooth height (indicated as H in FIG. 6), which may result in an improved throughput, i.e. the amount of harvested crop that can be processed by the crop processor per unit of time.

In an embodiment of the present invention, a tooth angle of 60° or less, preferably 50° or less, is applied.

In accordance with the present invention, the top surface is considered substantially flat when it has a curvature corresponding to the curvature of the roll, i.e. associated with the radius of the roll. Such radius e.g. being in the range of 100 mm to 150 mm. A substantially flat top surface having such a curvature has been found to enable the effects mentioned, i.e. provide an increased resistance to wear. When a substantially smaller curvature is applied, e.g. when the tooth profile is provided with a rounded tip, e.g. having a curvature radius of only a few mm, the resistance to wear substantially remains the same, nor would such a small curvature enable the application of a smaller tooth angle.

As mentioned, when the pair of crop processor rolls is assembled inside the housing, they are provided parallel to each other and having a gap between them. FIG. 7 schematically shows a top view of the assembled crop processor rolls. FIG. 7 schematically shows a pair of rolls 730 arranged parallel to each other and having a gap with a width d between them. Typically, a gap of 1 to 3 mm may be applied.

In order to manufacture the required crop processor rolls, the present invention provides in various manufacturing methods.

Typically, the crop processor rolls as applied in a crop processor are made from metal, often a ferrous metal. Starting from a cylindrically shaped roll, various processes are performed such as machining the teeth and hardening the machined roll, in order to arrive at a roll that can be applied in a crop processor.

In the present invention, the teeth of the crop processor rolls are provided with a substantially flat top surface having a predetermined width, e.g. in the range of 0.4 to 1 mm.

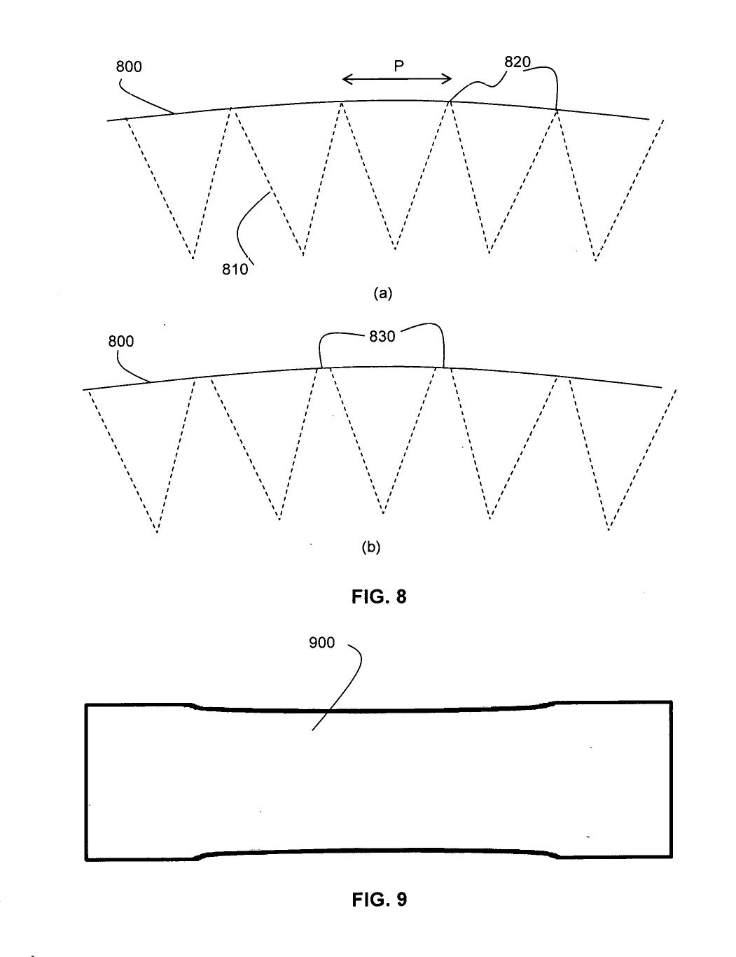

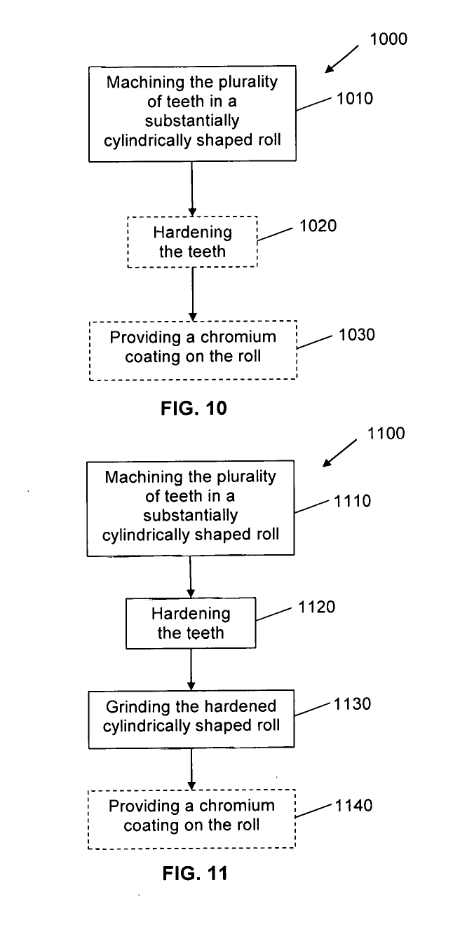

In a first manufacturing method 1000 according to the present invention, the substantially flat top surface of the teeth is obtained by machining the plurality of teeth in the substantially cylindrically shaped rolls, in a Step 1010, thereby maintaining part of an outer surface of the rolls unaffected. Two consecutive teeth on the roll thus have a surface in between them having a radius corresponding to the original radius of the cylindrical roll. This surface, which is thus a part of the outer surface of the roll corresponds to the substantially flat surface of the plurality of teeth. This manufacturing step 1010 is schematically illustrated in FIG. 8. FIG. 8(a) schematically shows part of the outer surface 800 of a cylindrical roll. Indicated by the dotted lines in FIG. 8(a) are the parts of the roll that are machined (i.e. removed) in the Step 1010 to form the teeth in a conventional crop processor roll. As can be seen, the profile 810 of the part that is removed, together with the pitch P is selected such that the teeth are provided with a sharp tip 820.

In the first manufacturing method 1000 according to the present invention, the teeth may be machined in the Step 1010 in such manner that part of the outer surface of the roll remains unaffected. This is illustrated in FIG. 8(b). More specifically, the parts of the roll that are machined or removed in the Step 1010 are spaced apart in such manner that a substantially flat top surface 830 is created, this surface being part of the outer surface 810 of the roll as originally provided. Various ways exist to realize the substantially flat top surface 830. In an embodiment, the same profile (e.g. tooth profile 810 of FIG. 8(a)) is applied but at an increased pitch P′=P+W (W being the width of the substantially flat top surface, as e.g. illustrated in FIG. 5). As an alternative to applying an increased pitch, the substantially flat top surface may also be realized by maintaining the pitch P and the tooth profile but decreasing the height of the teeth. As yet another alternative, the pitch P and height of the teeth may be maintained but another tooth profile is applied, a tooth profile having a smaller tooth angle.

As mentioned earlier, due to the creation of the substantially flat top surface of the teeth, an increased strength of the teeth (in particular the top part) is obtained. As such, in the first manufacturing method 1000 according to the invention, one may also select, for a given pitch, a comparatively small tooth angle that allows the teeth height to be increased as well. The application of such an increased teeth height (or depth), enabling a larger volume of harvested crop to be transported and processed by the crop processor.

In an embodiment of the first manufacturing method 1000 according to the present invention, the step 1010 of machining the teeth as described above is followed by a step 1020 of hardening the teeth.

In an embodiment, the manufacturing method may also comprise a final step 1030 of providing a Chromium coating on the roll.

In a second manufacturing method 1100 according to the present invention, the manufacturing of the crop processor rolls includes the steps of:

machining a plurality of teeth in the substantially cylindrically shaped rolls, Step 1110;

hardening the cylindrically shaped rolls, Step 1120;

grinding the hardened cylindrically shaped rolls to a diameter that is smaller than an initial diameter of the cylindrically shaped rolls, thereby providing the plurality of teeth with a substantially flat top surface, Step 1130;

In the second manufacturing method 1100 according to the present invention, the grinding step 1130 is thus applied to provide in the substantially flat top surface of the teeth.

In such method 1100, the teeth may initially be machined as e.g. shown in FIG. 8(a), in the Step 1110, thus having a sharp tip. After hardening in the Step 1120, this sharp tip is removed by the grinding step 1130, resulting in teeth having a substantially flat top surface. Performing a grinding step 1130 after a hardening step 1120 provides in a particular advantage in that any irregularities in the roll's outside diameter (e.g. caused by the hardening process), may be removed by grinding the roll to a smaller diameter, smaller than the diameter of the initial roll. Typically, due to the hardening process, the diameter of the crop processor rolls is smaller at the center of the rolls than at the end portions. This is schematically illustrated in FIG. 9, showing an exaggerated longitudinal cross-sectional view of a crop processor roll 900 after hardening. As a result, when two such roll are arranged in parallel, as e.g. shown in FIG. 7, a non-uniform gap will exist between the rolls, such gap adversely affecting the functionality of the crop processor. The larger the drop in diameter, the greater the influence on the functionality. In particular at the center of the rolls, such an increased gap is undesirable, because, in general, a comparatively large portion of the harvested crop is processed by the central region of the rolls. Due to the creation of a flat surface by grinding the hardened roll, one can correct the drop in diameter at the center of the roll.

It is worth noting that such a grinding step after hardening may also be applied in the first manufacturing method 1000 according to the present invention, to provide in a correction of the diameter of the roll.

The second manufacturing method 1100 according the present invention may also be finalized by applying a Chromium coating, Step 1140.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

The term coupled, as used herein, is defined as connected, although not necessarily directly, and not necessarily mechanically.

1. A crop processor for cracking crop kernels in a forage harvester, the crop processor comprising:
a housing having an inlet and an outlet; and
a pair of crop processor rolls mounted inside the housing, the pair of crop processor rolls being made of a metal, being arranged parallel to each other, and having a gap in between, the crop processor being configured to, during use, transport a flow of harvested crop, received from the inlet, through the gap towards the outlet
wherein each of the pair of crop processor rolls comprises a plurality of teeth arranged along a circumference of the each of the pair of crop processor rolls, the plurality of teeth of each of the pair of crop processor rolls having a height (H) in radial direction and a length extending in an axial direction of the each of the pair of crop processor rolls, and
wherein the plurality of teeth of each of the pair of crop processor rolls are manufactured to comprise a substantially flat top surface of a predetermined width (W).

2. The crop processor according to claim 1, wherein the flat top surface of each of the plurality of teeth of each of the pair of crop processor rolls is part of an initial outer surface of the each of the pair of crop processor rolls.

3. The crop processor according to claim 1, wherein the flat top surface is obtained by a grinding process.

4. The crop processor according to claim 3, wherein the grinding process is applied after a hardening process of the each of the pair of crop processor rolls.

5. The crop processor according to claim 1, wherein the top surface has a width (W) in a range of 0.5 to 1 mm.

6. The crop processor according to claim 1, wherein the plurality of teeth of each of the pair of crop processor rolls have a symmetrical shape.

7. The crop processor according to claim 1, wherein a tooth angle (TA2) of the plurality of teeth of each of the pair of crop processor rolls is less than 60°, preferably less than 50°.

8. A forage harvester comprising a crop processor according to claim 1.

9. A manufacturing method for a crop processor for cracking kernels in a forage harvester, the method comprising the steps of:
manufacturing a pair of crop processor rolls by
machining a plurality of teeth in each of a pair of substantially cylindrically shaped rolls, while maintaining part of an outer surface of each of the pair of substantially cylindrically shaped rolls unaffected, the part of the outer surface of each of the pair of substantially cylindrically shaped rolls forming a substantially flat top surface of the plurality of teeth of each of the pair of substantially cylindrically shaped rolls, the substantially flat top surface having a predetermined width (W).
assembling the pair of crop processor rolls into a housing having an inlet and an outlet, by arranging the pair of crop processor rolls to be parallel to each other and to have a gap in between.

10. The manufacturing method according to claim 9, wherein the manufacturing step further comprises:
hardening the each of the pair of substantially cylindrically shaped metal rolls after the machining of the plurality of teeth in the each of the pair of substantially cylindrically shaped rolls.

11. A manufacturing method for a crop processor for cracking kernels in a forage harvester, the method comprising the steps of:
manufacturing a pair of crop processor rolls by:
machining a plurality of teeth in each of a pair of substantially cylindrically shaped rolls;
hardening the pair of substantially cylindrically shaped rolls;
grinding the hardened substantially cylindrically shaped rolls to a diameter that is smaller than an initial diameter of the pair of substantially cylindrically shaped rolls, to provide each of the plurality of teeth in each of the pair of ground, hardened substantially cylindrically shaped rolls with a substantially flat top surface of a predetermined width (W); and
assembling the pair of crop processor rolls into a housing having an inlet and an outlet, by arranging the pair crop processor rolls to be parallel to each other and to have a gap in between.

12. The manufacturing method according to claim 11, wherein the manufacturing step further comprises a final step of:
providing a Chromium coating to each of the pair of ground, hardened substantially cylindrically shaped rolls.

13. A crop processor roll for use in a crop processor for cracking kernels, the crop processor roll comprising:
a plurality of teeth arranged along a circumference of the crop processor roll, the plurality of teeth having a height (H) in a radial direction and a length extending in an axial direction of the crop processor roll,
wherein each of the plurality of teeth of the crop processor roll comprises a substantially flat top surface of a predetermined width (W).

14. The crop processor roll of claim 13, wherein the top surface of each of the plurality of teeth has a width (W) in a range of 0.5 to 1 mm.

15. The forage harvester of claim 8, wherein the flat top surface of each of the plurality of teeth of each of the pair of crop processor rolls is part of an initial outer surface of the each of the pair of crop processor rolls.

16. The forage harvester of claim 8, wherein the flat top surface is obtained by a grinding process.

17. The forage harvester of claim 16, wherein the grinding process is applied after a hardening process of the each of the pair of crop processor rolls.

18. The forage harvester of claim 8, wherein the top surface has a width (W) in a range of 0.5 to 1 mm.

19. The forage harvester of claim 8, wherein the plurality of teeth of each of the pair of crop processor rolls have a symmetrical shape.

20. The forage harvester of claim 8, wherein a tooth angle (TA2) of the plurality of teeth of each of the pair of crop processor rolls is less than 60°, preferably less than 50°.
